(19) United States
(12) Patent Application Publication
(10) Pub. No.: US 2025/0368916 A1
(43) Pub. Date: Dec. 4, 2025

(54) ALCOHOL PRETREATMENT TO REMOVE WATER TO PREPARE OLEAGINOUS MATERIAL FOR SUBSEQUENT ALCOHOL-BASED SOLVENT EXTRACTION

(71) Applicant: Crown Iron Works Company, Blaine, MN (US)

(72) Inventors: Benjamin Wayne Floan, Andover, MN (US); Nicholas Ollila, Fridley, MN (US); Wade Steven Martinson, Minneapolis, MN (US)

(21) Appl. No.: 18/680,990

(22) Filed: May 31, 2024

(51) Int. Cl. C11B 1/04; B01D 11/04; B01D 15/08; B01D 61/36; C11B 3/00

(52) U.S. Cl. CPC C11B 1/04; B01D 11/0488; B01D 11/0492; B01D 15/08; B01D 61/362; C11B 3/006

(57) ABSTRACT

Devices, systems, and techniques can be provided for processing an oil-containing material with an alcohol-based solvent to extract oil from the material. In some examples, a system includes a pretreatment dehydration vessel that removes water from the oil-containing material prior to processing the oil-containing material in an extractor to extract oil from the material. An alcohol-based solvent may also be supplied to the dehydration vessel to remove water from the oil-containing material, thereby generating a dehydrated material that can be extracted in a downstream extractor.

### TECHNICAL FIELD

This disclosure relates to solvent extraction and, more particularly to preparing an oleaginous material for liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover oil from oil sands and other petroleum-rich materials. Typically, the petroleum-rich material is ground into small particles and then passed through an extractor to extract the oil from the solid material into a surrounding organic solvent.

During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock.

In practice, solvents such as hexane are typically used for extracting oil from oleaginous materials. The oil and/or extracted solid can be used as an intermediate or end product for human and/or animal consumption. While the solvent is removed from the oil and/or extracted solid prior to consumption, consumers are increasingly sensitive about food production processes and standards. Ethanol is an alternative solvent to hexane that can be used to separate oil from various oleaginous materials. Ethanol is GRAS (Generally Recognized As Safe), can be produced organically, including from renewable feedstocks, and is already accepted by the consuming public as a component of alcoholic beverages.

### SUMMARY

In general, this disclosure is directed to devices, systems, and techniques, for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. Similarly, the concentration of oil in the solvent may increase as the solvent moves through the extractor from the solvent inlet to the solvent outlet.

In addition to extracting oil from the oil-containing feedstock, the alcohol-based solvent can remove water from the feedstock being processed. The water may be in the form of extracellular water carried outside of the cellular structure of the material being processed (e.g., bulk surface moisture carried in with the incoming feedstock). Additionally or alternatively, the water may be in the form of intracellular water carried inside of the cellular structure of the material being processed. In either case, the water may transfer from the material being processed to the solvent (e.g., that also contains oil extracted from the material being processed).

After extraction, the alcohol-based solvent containing extracted oil and water from the feedstock material can be processed to recover the solvent for reuse. In practice, when using an alcohol-based solvent such as ethanol, an azeotropic mixture can form. An azeotrope mixture is a constant-boiling mixture with a constant mole fraction of two or more components (water and alcohol) in the vapor and liquid phases that cannot be separated by simple distillation, making separation and recovery of the alcohol from the water challenging. For these and other reasons, the incoming feedstock to be processed in the extractor may be pretreated to reduce the amount of incoming water carried with the feedstock that will subsequently transfer to the solvent and need to be removed when recovering the solvent.

In some implementations of the present disclosure, systems and techniques are described for pretreating a material prior to extraction to remove water from the material prior to introducing the material into an extractor. In particular, a feedstock material to be processed can be contacted with a water removal solvent that causes water to transfer from the feedstock material into the water removal solvent. The water removal solvent having an increased concentration of water attributable to the water removed from the feedstock material can then be separated from the feedstock material to produce a solvent-wetted feedstock having a reduced concentration of water. This solvent-wetted feedstock can then be introduced into the extractor, typically while still solvent-wetted although optionally with intermediate drying, to subsequently extract oil from the feedstock in the extractor.

The water removal solvent used to pre-dry the feedstock material (e.g., remove water from the feedstock material) may be an alcohol-based solvent, which may or may not contain the same alcohol as the alcohol-based solvent subsequently used in the extractor to extract oil form the feedstock. For instance, in one example, the feedstock is contacted with ethanol to remove water from the feedstock. The ethanol and water removed from the feedstock is then separated from the feedstock to produce an ethanol-wet feedstock. This ethanol-wet feedstock is then introduced into an extractor where a different portion of ethanol (e.g., anhydrous ethanol, ethanol having a lower concentration of water than the ethanol and water mixture separated from the feedstock to produce the ethanol-wet feedstock) is contacted with the feedstock to extract oil from the feedstock.

Independent of the specific type of alcohol(s) used to remove water from the feedstock before entering the extractor and subsequently to extract oil from the feedstock in the extractor, the temperature of the feedstock and/or alcohol-based solvents can be controlled to preferentially remove water in the first instance without removing oil and to preferentially remove oil in the second instance. For example, when initially processing the feedstock material to remove water, the material may be contacted with a first alcohol-based solvent at a temperature below that at which oil substantially extracts from the material. This can remove water from the material without removing a significant amount of oil from the material, which is desirably retained with the material for subsequent removal in the extractor. When subsequently processing the feedstock material to remove oil in the extractor, the material may be contacted with a second alcohol-based solvent at a temperature above that at which oil substantially extracts from the material.

By pretreating the feedstock material to remove water prior to performing oil extraction using the feedstock material, systems and techniques of the disclosure can reduce or eliminate the introduction of excess water carried in with the feedstock into the extractor. This can limit the amount of water that transfers from the feedstock into the solvent during extraction in which oil is extracted from the feedstock into the solvent in the extractor. As a result, downstream processing to remove water from the extraction solvent prior to reuse can be reduced.

The first solvent that is used to remove water from the feedstock material prior to oil extraction can be processed to separate water removed from the feedstock (resulting in dilution of the first solvent) from the solvent itself for subsequent reuse. The volume of solvent used during the pretreatment step to remove water, and correspondingly the volume of the combined solvent and liberated water stream needing to be processed during solvent recovery, may be significantly less than the amount of amount of solvent used during subsequent oil extraction. As a result, by generating a segregated stream during pretreatment separate from the miscella stream generated during downstream extraction, the processing demands to remove water and recover solvent from the pretreatment stream are less than if needing to similarly process the full miscella stream containing all water removed from the incoming feedstock.

Additionally or alternatively, using the first solvent to remove water from the feedstock material prior to oil extraction may produce a water-containing solvent stream having a higher concentration of water than if the corresponding amount of water were combined with the full volume of solvent used during oil extraction. The resulting water-containing solvent stream with higher water concentration may be more easily dewatered, e.g., during a subsequent membrane separation process, as the higher water concentration may drive an increased flux across the separation membrane as compared to if dewatering a solvent stream with lower water concentration.

In one example, a method is described that involves removing water from an oil-containing material to be processed by contacting the oil-containing material with a first solvent that includes ethanol at a temperature below that at which oil substantially extracts from the oil-containing material into the first solvent. This produces a dehydrated oil-containing material and a residual solvent that includes the first solvent and water removed from the oil-containing material. The example method also involves separating the residual solvent from the dehydrated oil-containing material and removing water from the residual solvent to recover the first solvent. The example method further involves contacting the dehydrated oil-containing material with a second solvent that includes ethanol in an extractor at a temperature above that at which oil substantially extracts from the dehydrated oil-containing material into the second solvent, thereby producing an extracted material and a miscella. The example method further involves separating the second solvent from the miscella, thereby forming an extracted oil.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extraction system according to the disclosure in which a solid material is pretreated to dehydrate the material prior to extraction.

FIG. 2 is an illustration of an example extractor configuration that can be used in the system of FIG. 1.

### DETAILED DESCRIPTION

In general, the disclosure relates to liquid-solid extractor systems and processes that enable the extraction of one or more desire products from solid material flows. In some examples, the solid material is processed in a continuous flow extractor that conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

The solvent discharged from the extractor, which may be referred to as a miscella, contains extracted components (e.g., oil, carbohydrates, sugars) from the solid feedstock. The solvent-wet solid material discharged from the extractor may be residual solid feedstock having undergone extraction.

In some configurations according to the present disclosure, systems and techniques are described for pretreating the solid feedstock prior to introducing the feedstock into the extractor for subsequent extraction. The pretreatment can dehydrate the solid feedstock by contacting the feedstock with hydrophilic solvent (e.g., a polar protic solvent having a least one hydrogen atom connected directly to an electronegative atom). This can cause water carried by the feedstock to transfer from the solid feedstock (e.g., surface of the feedstock, intracellular structure) into the solvent, thereby dehydrating the feedstock. The resulting solvent with increased concentration of water can be separated from the resulting solvent-wet feedstock, providing a solvent-wet dehydrated feedstock that can be subsequently extracted to remove organic molecules (e.g., oil) from the feedstock.

In some implementations, the solvent used to dehydrate the solid feedstock has the same composition (e.g., same constituent alcohol) as a solvent used to subsequently extract organic molecules from the feedstock within an extractor. A mixture of the solvent and water may form an azeotrope that cannot be readily separated based on vapor pressure (e.g., thermal separation). In these situations, the solvent with increased concentration of water produced from pretreatment of the feedstock may be processed through one or more separation devices that function to remove water for alcohol without relative vapor pressure differences between the water and alcohol. For example, the solvent with increased concentration of water produced from pretreatment of the feedstock may be processed in a pervaporation system and/or molecular sieve to separate water from the alcohol, increasing the concentration of the alcohol for subsequent reuse.

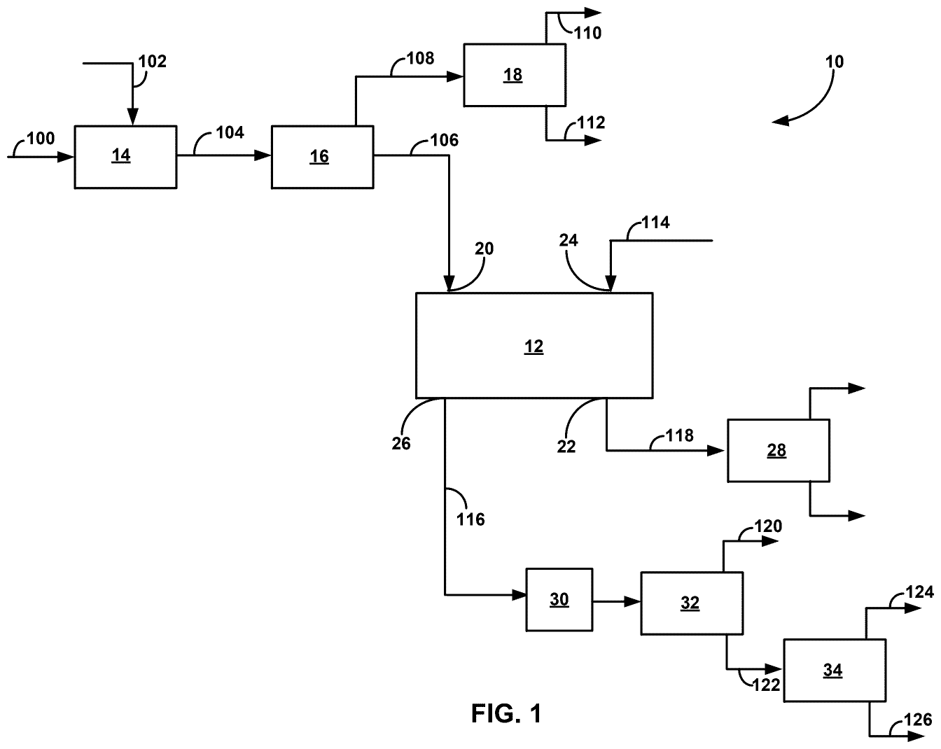

FIG. 1 is a block diagram illustrating an example extraction system 10 according to the disclosure in which a solid material is pretreated to dehydrate the material prior to extraction. System 10 includes an extractor 12, a dehydration vessel 14, and a separator 16. Extractor 12 has a feed inlet 20 that can receive a dehydrated solid material after water has been removed from the solid material by solvent contact in dehydration vessel 14 and separate separation in separator 16. Extractor 12 also has a feed outlet 22 that can discharge the solid particulate material after is has undergone extraction to remove extractable organic components (e.g., oil) and has a lower concentration of extract than the incoming dehydrated solid material. Extractor 12 also has a solvent inlet 24 configured to introduce a fresh solvent into the extractor and a solvent outlet 26 configured to discharge a miscella formed via extraction of extractable components from the solid material.

In operation, the solid material being processed is contacted with solvent within extractor 12 (e.g., in counter current fashion), causing organic components soluble within the solvent to be extracted from the solid material into the solvent. Extractor 12 can process any desired solid material using any suitable extraction fluid. Example types of solid material that can be processed using extractor 12 include, but are not limited to, oleaginous matter, such as soybeans, rapeseed, sunflower seed, peanuts, cottonseed, palm kernels, and corn germ; oil-bearing seeds and fruits; asphalt-containing materials (e.g., asphalt-containing roofing shingles that include an aggregate material such as crushed mineral rock, asphalt, and a fiber reinforcing); alfalfa; almond hulls; anchovy meals; bark; coffee beans and/or grounds, carrots; chicken parts; diatomic pellets; fish meal; hops; oats; pine needles; tar sands; vanilla; and wood chips and/or pulp.

The material processed in dehydration vessel 14 to subsequently provide a dehydrated material that is extracted in extractor 12 can be a full fat material that has not undergone prior stages of solvent extraction intended to remove organic molecules from the material. For example, depending on the type of solid material to be processed in extraction system 10, the incoming solid material may be cracked and/or flaked from raw form to produce a size-reduced solid material having substantially a same fat content as the raw solid material following harvesting. The size-reduced solid material may be pressed in a mechanical press to squeeze comparatively easily liberated oil from the solid material before being supplied as the input solid material for extraction system 10.

In some examples, the solid material to be processed in extraction system 10 carries water with the incoming material. The water may be in the form of extracellular water carried outside of the cellular structure of the material being processed (e.g., surface moisture carried in with the incoming material) and/or intracellular water carried inside of the cellular structure of the incoming material. In either case, extraction system 10 may pretreat the incoming material by contacting the material with a solvent to dehydrate the material following by a separation step to separate the solvent with water removed from the incoming material from the resulting dehydrated solid material.

In the example of FIG. 1, extraction system 10 shows dehydration vessel 14 receiving an incoming solid material 100 to be processed. Dehydration vessel 14 also receives a first solvent 102. Solid material 100 is contacted with first solvent 102 in dehydration vessel 14 to remove water from the solid material. The conditions within dehydration vessel 14 may be configured such that a majority of the water carried by the incoming solid material 100 transfers to first solvent 102 without extracting substantial oil from the solid material. By transferring water carried by incoming solid material 100 to first solvent 102 in dehydration vessel 14, the dehydration vessel can produce a dehydrated solid material (e.g., dehydrated oil-containing material) and a residual solvent that includes first solvent 102 and water removed from the solid material (e.g., oil-containing material). In some examples, a combined stream 104 of the dehydrated solid material and residual solvent with water discharges from the dehydration vessel and is conveyed to a separation unit 16. In other examples, the functionality of separation unit 16 may be integrated into dehydration vessel 14 rather than configured as a separate unit operation downstream of dehydration vessel 14.

Dehydration vessel 14 can be implemented using a variety of different device configurations. Dehydration vessel 14 can be a tank, reservoir, section of piping, and/or other vessel in which solid material 100 and first solvent 102 can combine and intermix to allow water to transfer from the solid material to the solvent. Dehydration vessel 14 may be implemented using one or more vessels that can be connected in parallel and/or in series. Dehydration vessel 14 may or may not include a mixing apparatus (e.g., a driven impeller, static mixer blades) to help intermix solid material 100 and first solvent 102. The vessel may operate at ambient pressure, vacuum pressure, and/or positive pressure.

Dehydration vessel 14 may operate in batch mode in which solid material 100 and first solvent 102 are combined and held in the vessel (e.g., with mixing) for a residence period of time before being discharged from vessel. Alternatively, dehydration vessel 14 may operate in a continuous mode in which solid material 100 and/or first solvent 102 continuously flow into the vessel while dehydrated solid material and residual solvent with water continuously discharges from the dehydration vessel during operation.

Independent of whether dehydration vessel 14 operates in batch mode or continuous mode, solid material 100 can be contacted by first solvent 102 in the vessel for a period of time sufficient to allow a desired amount of water (e.g., a majority weight percent) present in the incoming solid material 100 to transfer from the solid material to the solvent. In some implementations, solid material 100 contacts first solvent 102 in dehydration vessel 14 for a period of time of at least five minutes before the resulting dehydrated solid material and residual solvent are discharged from the vessel, such as at least 10 minutes, at least 15 minutes, at least 20 minutes, at least 30 minutes, at least 45 minutes, or at least one hour. After a sufficient period of time, further contact time between the incoming solid material 100 and the first solvent 102 may not result in the transfer of any significant amount of additional water from the solid material to the first solvent. Accordingly, in some implementations, solid material 100 contacts first solvent 102 in dehydration vessel 14 for a period of time of less than two hours, such as less than one hour, less than 45 minutes, less than 30 minutes, less than 25 minutes, less than 20 minutes, less than 15 minutes, or less than 10 minutes. For example, solid material 100 may contact first solvent 102 in dehydration vessel 14 for a period of time ranging from five minutes to 45 minutes, such as from 10 minutes to 30 minutes.

The temperature conditions of solid material 100, first solvent 102, and/or dehydration vessel 14 may be controlled to limit the extraction of oil from solid material 100 into the first solvent 102 within the dehydration vessel. For example, the temperature of solid material 100, first solvent 102, and/or dehydration vessel 14 may be controlled so that solid material 100 is contacted by first solvent 102 at a temperature below that at which oil substantially extracts from the solid material into the first solvent. This helps ensure that the oil remains in solid material 100 for subsequent removal in extractor 12 rather than being lost during the water removal process in dehydration vessel 14.

In specific implementations, the temperature of solid material 100, first solvent 102, and/or dehydration vessel 14 may be controlled so that less than 15 wt % of the oil in incoming solid material 100 is extracted and transferred to first solvent 102 in dehydration vessel 14, such as less than 12 wt %, less than 10 wt %, less than 8 wt %, less than 7 wt %, less than 6 wt %, less than 5 wt %, less than 4 wt %, less than 3 wt %, less than 2 wt %, or less than 1 wt %. For example, the amount of oil incoming solid material 100 that is extracted and transferred to first solvent 102 in dehydration vessel 14 may range from 1 wt % to 8 wt %, such as from 2 wt % to 7 wt %, or from 3 wt % to 6 wt %. The amount of oil extracted and removed in dehydration vessel 14 may be determined by comparing the oil content of solid material 100 to the oil content of the resulting dehydrated solid material.

The specific temperature to which solid material 100, first solvent 102, and/or dehydration vessel 14 is controlled to ensure that the temperature is below that at which oil substantially extracts from the solid material into the first solvent may vary depending on the type of feedstock being processed and the type of solvent used. In some examples, the temperature is less than 50 degrees Celsius, such as less than 40 degrees Celsius, less than 30 degrees Celsius, or less than 20 degrees Celsius. For example, the temperature may range from 0 degrees Celsius to 30 degrees Celsius, such as from 0 degrees Celsius to 25 degrees Celsius. In practice, the temperature may typically be controlled by controlling the temperature of the first solvent 102 and/or the temperature of dehydration vessel 14, e.g., via direct and/or indirect temperature control (e.g., cooling). Depending on the temperature of operation, dehydration vessel 14 may be sized to operate without a headspace and/or an inert gas blanket (e.g., a nitrogen blanket) may be provided to the headspace for safe operation.

The amount of water in the incoming solid material 100 removed and transferred into first solvent 102 in dehydration vessel 14 may vary, e.g., depending on the residence time and temperature conditions. In some examples, at least 50 weight percent of the water present in the incoming solid material 100 is transferred to first solvent 102 in dehydration vessel 14, such as at least 60 weight percent, at least 70 weight percent, at least 80 weight percent, at least 90 weight percent, or at least 95 weight percent. The amount of water removed in dehydration vessel 14 may be determined by comparing the water content of incoming solid material 100 to the water content of the resulting dehydrated solid material.

For instance, in some examples, incoming solid material 100 has a water content greater than five weight percent prior to dehydration via dehydration vessel 14, such as great than six weight percent, greater than seven weight percent, greater than eight weight percent, greater than nine weight percent, or greater than 10 weight percent. For example, solid material 100 may have a water content ranging from five weight percent to 12 weight percent prior to dehydration via dehydration vessel 14. In some examples, solid material 100 is dehydrated via dehydration vessel 14 to a water content of 5 weight percent or less, such as 3 weight percent or less, 2 weight percent or less, or 1 weight percent or less. The resulting dehydrated solid material may contain a residual amount of moisture.

In some implementations, an optional dryer is used to dry incoming solid material 100 prior to dewatering via dehydration vessel 14. The dryer can reduce the amount of water in the incoming solid material prior to further water removal by dehydration vessel 14. Accordingly, a portion of the water in incoming solid material 100 may be removed via the dryer and another portion of the water in incoming solid material 100 may be removed via dehydration vessel 14.

When used, the dryer may be an indirect dryer and/or a direct dryer. For example, the dryer may indirectly dry incoming solid material 100, e.g., by passing a thermal transfer fluid through a jacketed drying vessel. Additionally or alternatively, the dryer may directly dry incoming solid material 100, e.g., by introducing a hot gas (e.g., dried air, nitrogen) into the solid material to pick up moisture and then venting the gas out of the vessel.

When used, the dryer may dry incoming solid material 100 at a temperature effective to vaporize at least a portion of the moisture present in the material but also at a temperature not so hot as to damage the solid material (e.g., change the structure and/or degrade the nutritive properties of the material). In some implementations, the dryer dries the solid material at a temperature greater than 30° C., such as greater than 50° C., or greater than 60° C., greater than 70° C., greater than 80° C., or greater than 100° C. Additionally alternatively, the dryer may dry the solid material at a temperature less than 125° C., such as less than 100° C., or less than 80° C. For example, the dryer may dry the solid material at a temperature below the boiling point of water. In some examples, the dryer may dry the solid material at a temperature ranging from 40° C. to 90° C., such as from 50° C. to 80° C. The dryer may typically operate at atmospheric pressure although, in other examples, may be configured to operate at a non-atmospheric pressure (e.g., vacuum pressure, positive pressure). In some implementations, the dryer may reduce the moisture content of incoming solid material by at least 0.5 weight percent, such as by at least one weight percent, by at least two weight percent, by at least three weight percent, or by at least four weight percent. This can provide a partially-dried incoming solid material further dewatering by dehydration vessel 14.

With further reference to dehydration vessel 14, after first solvent 102 contacts solid material 100 in dehydration vessel 14, the resulting dehydrated solid material and resulting residual solvent (including first solvent 102 in water removed from the solid material) can be separated from each other. In the illustrated configuration of FIG. 1, extraction system 10 is shown as including a separation unit 16 downstream of dehydration vessel 14. Combined stream 104 of the dehydrated solid material and residual solvent with water can discharge from dehydration vessel 14 and be conveyed to separation unit 16. Separation unit 16 can be implemented using one or more devices that physically separate the dehydrated solid material from the residual solvent. In various examples, separation unit 16 can be implemented using a gravity drainage screen, a decanter (e.g., gravity decanter), a centrifuge, a cyclone, a press, and/or other suitable unit operation. As noted above, while illustrated as a separate unit operation from dehydration vessel 14, the functionality of separation unit 16 may be integrated with the vessel (e.g., such as using a gravity drainage screen that gravity drains residual solvent from the dehydrated solid material while discharging from the dehydration vessel).

Independent of the specific configuration of separation unit 16 and whether the unit is physically separate from dehydration vessel 14, the pretreatment system of extraction system 10 can generate a dehydrated solid material 106 (e.g., dehydrated oil-containing material) and a residual solvent 108 that includes first solvent 102 and water removed from solid material 100 into the solvent (e.g., absent a residual solvent carried out with and wetting the dehydrated solid material).

Residual solvent 108 can be processed to remove water from the residual solvent (water transferred from solid material 100 to the solvent in dehydration vessel 14) to recover first solvent 102 for reuse. In the example of FIG. 1, extraction system 10 is illustrated as including a water removal unit 18 that receives residual solvent 108. Water removal unit 18 can process the received residual solvent 108 and separate water from the residual solvent, thereby increasing the alcohol concentration of the received residual solvent 108 stream for recycling back to dehydration vessel 14 and/or other use. In practice, residual solvent 108 may be filtered to remove solid particles prior to being processed in water removal unit 18. Water removal unit 18 can separate water from the received residual solvent 108 to generate a recovered first solvent 110 having an increased concentration of alcohol as compared to residual solvent 108 and a separated water 112. Recovered first solvent 110 may have the same composition (e.g., relative amount of water) as first solvent 102, e.g., such that recovered first solvent 110 can be recycled back to again form first solvent 102.

In different examples, water removal unit 18 may be implemented using one or more stages of a molecular sieve (mole sieve), one or more stages of a pervaporation system, and/or one or more stages of a vapor permeation membrane. In general, a molecular sieve utilizes a material with small pores sized to allow comparatively small molecules (e.g., water) to enter the back for entrapment while comparatively larger molecules (e.g., alcohol) are unable to pass into the molecular pores. The molecular sieve can be periodically regenerated, e.g., by heating and purging with a carrier gas or under vacuum, to remove the separated water 112 trapped in the sieve. By contrast, pervaporation generally involves a process of separating a mixtures of liquids by partial vaporization through a non-porous or porous membrane. The pervaporation process can proceed with initial permeation through a membrane by a permeate followed by evaporation into the vapor phase, generating a continuous stream of separated water 112 from the residual solvent 108.

In some implementations, such as when using a zeolite-based membrane (e.g., a zeolite-based pervaporation membrane) for water removal unit 18, additional processing may be performed on residual solvent 108 between separation unit 16 and water removal unit 18. For example, an oil removal unit may be included in extraction system 10 to provide an oil-removal step performed on residual solvent 108 between separation unit 16 and water removal unit 18. The oil removal unit can reduce the concentration of oil in residual solvent 108, e.g., to a concentration less than 1 weight percent, such as less than 0.5 weight percent, less than 0.1 weight percent, less than 0.05 weight percent, or less than 0.01 weight percent. In one example, the oil removal unit is implemented using a sacrificial zeolite material that adsorbs oil from residual solvent 108 before dewatering by water removal unit 18. When water remove 18 is implemented using polymeric membrane(s) (e.g., a polymer-based pervaporation membrane, vapor permeation membrane, and/or molecular sieve) oil removal prior to dewatering may or may not be included.

Independent of the configuration of water removal unit 18, the water removal unit may remove at least 10 weight percent of the water in residual solvent 108, such as at least 25 weight percent, at least 50 weight percent, at least 75 weight percent, or at least 90 weight percent. For example, water removal unit may remove between 25 weight percent and 95 weight percent of the water in residual solvent 108, such as from 50 weight percent to 90 weight percent of the water in residual solvent 108.

In some examples, the concentration of water in residual solvent 108 is at least 5 weight percent, such as at least 7.5 weight percent, at least 10 weight percent, at least 15 weight percent, or at least 17.5 weight percent. For example, concentration of water in residual solvent 108 may be within a range from 5 weight percent to 25 weight percent, such as from 8 weight percent to 20 weight percent, or from 10 weight percent to 15 weight percent. After processing in water removal unit 18, recovered first solvent 110 can have a concentration of water less 6 weight percent, such as less than 5 weight percent, less than 4 weight percent, less than 3 weight percent, or less than 2 weight percent. For example, recovered first solvent 110 may have a concentration of water within a range from 0.5 weight percent to 3 weight percent, such as from 1 weight percent to 2.5 weight percent.

In addition to or in lieu of removing oil from residual solvent 108 between separation unit 16 and water removal unit 18, system 10 may include one or more process units to remove solids (e.g., precipitated solids) from residual solvent 108 prior to water removal unit 18. For example, system 10 may include a filter, centrifuge, decanter, and/or other solid removal unit to remove residual solids prior to water removal unit 18. Such residual solids may be solid particulate or fines from the feed material carried over into residual solvent 108, precipitated solids (e.g., precipitated sugars), and/or other solid material present in the otherwise liquid residual solvent.

Dehydrated solid material 106 can be supplied to extractor 12 for subsequent extraction in the extractor. In some applications, dehydrated solid material 106 that is wetted with first solvent 102 from dehydration vessel 14 is supplied to extractor 12 via feed inlet 20 (e.g., such that the dehydrated material enters the extractor solvent wetted). In some examples, a drier dries the dehydrated solid material 106 before subsequently delivering a dried dehydrated solid material to extractor 12. For example, a direct or indirect dryer may be used to vaporize residual first solvent and/or water from the dehydrated solid material 106 prior to delivery to extractor 12. When used, the dryer may indirectly dry the dehydrated solid material, e.g., by passing a thermal transfer fluid through a jacketed drying vessel. Additionally or alternatively, the dryer may directly dry the dehydrated solid material, e.g., by introducing a hot gas (e.g., dried air, nitrogen) into the dehydrated solid material to vaporize residual first solvent 102 and/or water that is then venting as a gas out of the vessel.

When used, a dryer may dry the dehydrated solid material at a temperature greater than 30° C., such as greater than 50° C., or greater than 60° C., greater than 70° C., greater than 80° C., or greater than 100° C. Additionally alternatively, the dryer may dry the dehydrated solid material at a temperature less than 125° C., such as less than 100° C., or less than 80° C.

Independent of whether dehydrated solid material 106 is or is not dried prior to being supplied to extractor 12, the dehydrated solid material can enter the extractor via feed inlet 20. A second solvent 114 can enter extractor 12 via solvent inlet 24. The second solvent 114 can contact dehydrated solid material 106 in extractor 12 through one or more stages of extraction. Within the extractor, organic components (e.g., oil) soluble within second solvent 114 can be extracted from dehydrated solid material 106 in the second solvent. This can produce a miscella 116 composed of second solvent 114 and organic components (e.g., oil) extracted from dehydrated solid material 106 into the solvent that discharges from solvent outlet 26. This can also produce a solvent-wet extracted material 118 that discharges from feed outlet 22.

The temperature conditions of dehydrated solid material 106, second solvent 114, and/or extractor 12 may be controlled to promote extraction of oil from dehydrated solid material 106 into the second solvent 114 within extractor 12. For example, the temperature of dehydrated solid material 106, second solvent 114, and/or extractor 12 may be controlled so that dehydrated solid material 106 is contacted by second solvent 114 at a temperature above that at which oil substantially extracts from the dehydrated solid material into the second solvent.

In specific implementations, the temperature of dehydrated solid material 106, second solvent 114, and/or extractor 12 may be controlled so that at least 80 wt % of the oil in dehydrated solid material 106 is extracted and transferred to second solvent 114 in extractor 12, such as at least 90 wt %, at least 95 wt %, or at least 98 wt %. The amount of oil extracted and removed in extractor 12 may be determined by comparing the oil content of dehydrated solid material 106 to the oil contact of extracted material 118.

The specific temperature to which dehydrated solid material 106, second solvent 114, and/or extractor 12 is controlled to ensure that the temperature is above that at which oil substantially extracts from the dehydrated solid material into the second solvent may vary depending on the type of feedstock being processed and the type of solvent used. In some examples, the temperature is greater than 50 degrees Celsius, such as greater than 60 degrees Celsius, or greater than 65 degrees Celsius. For example, the temperature of the miscella 116 generated by the extractor may range from 60 degrees Celsius to 90 degrees Celsius, such as from 65 degrees Celsius to 80 degrees Celsius, such as approximately 70 degrees Celsius.

First solvent 102 may be a polar protic solvent that is water soluble. Second solvent 114 may be a polar protic solvent that is water soluble or a non-polar solvent that is water insoluble (e.g., hexane). In some examples, first and second solvents 102, 114 are both polar protic solvents that are water soluble. For example, first and second solvents 102, 114 may each be alcohol-based solvents. Example alcohol-based solvents that can be used for first solvent 102 and second solvent 114 include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent has greater than 90 weight percent alcohol and less than 10 weight percent water, such as greater than 95 weight percent alcohol and less than 5 weight percent water, or greater than 98 weight percent alcohol and less than 5 weight percent water. In each case, the foregoing water concentrations may be prior to dilution by water with the incoming solid material.

In some examples, first solvent 102 and second solvent 104 are the same solvent each having substantially the same composition. For example, first solvent 102 and second solvent 104 may each include ethanol, such as hydrous or anhydrous ethanol. In other examples, first solvent 102 and second solvent 104 may have different compositions, such as different types of alcohols or different concentrations of alcohol to water.

First solvent 102 and second solvent 104 may or may not be segregated from each other in the implementation of extractor system 10. For example, when first solvent 102 and second solvent 104 have the same composition, the solvents may be drawn from a shared tank or reservoir and, after recovery, recycled back to the same shared tank or reservoir. In other examples, first solvent 102 and second solvent 104 are segregated from each other such that solvent used in dehydration vessel 14 is not intermixed with solvent used in extractor 12 (e.g., except for solvent carryover with solid material transferring from the dehydration vessel to the extractor).

Miscella 116 and solvent-wet extracted material 118 produced by extractor 12 can be further processed following discharge from extractor 12. For example, to recover solvent from the solvent-wet extracted material 118 steam and further prepare the residual solids material for end use, the solvent-wet solids stream may be desolventized using mechanical and/or thermal desolventization devices. In the example of FIG. 1, system 10 includes a desolventizer 28. Desolventizer 28 can be implemented using one or more stages of mechanical and/or thermal treatment to remove solvent from the solvent-wet solids stream, thereby producing a dried extracted solid material (which may also be referred to as a desolventized extracted solid material). It should be appreciated that reference to a dried and/or desolventized solid material refers to a material that is comparatively dried and desolventized and does not require complete drying or desolventization or that the material be devoid of solvent. Rather, the material may be dried and desolventized to a practical level effective for downstream use and/or processing.

In some examples, desolventizer 28 heats the extracted solid material (the solvent-wet extracted material 118) produced by extractor 12 to vaporize solvent from the stream to produce a dried solid material. While desolventizer 28 may inject steam into the extracted solid material in some implementations, in other implementations, desolventizer 28 may desolventize the extracted solid material without adding moisture to the material during desolventizing. For example, desolventizer 28 may directly and/or indirectly heat the extracted solid material without injecting steam into the extracted solid material. Desolventizer 28 may indirectly heat the extracted solid material by passing a heat transfer fluid through a tray that the extracted material contacts while passing through a desolventizing vessel and/or through a jacket surrounding at least a portion of the desolventizing vessel. Additionally or alternatively, desolventizer 28 may introduce a heated gas substantially devoid of moisture (e.g., dried air, nitrogen) into an interior of the desolventizing vessel and extracted solid material therein.

Configuring desolventizer 28 to desolventize the extracted solid material without introducing additional moisture to the extracted solid material may be useful for subsequent solvent recovery. As discussed above, when using an alcohol solvent such as ethanol, the water and alcohol may form an azeotropic mixture that is challenging to separate for solvent recovery. Accordingly, desolventizing in the absence of added moisture may be useful in that the solvent vaporized by desolventizer 28 may have little or no water mixed with the alcohol that needs to be removed before the solvent can be recycled to extractor 12.

In different examples, desolventizer 28 can be implemented using a cooker, jacketed paddle mixer, bulk solids heat exchanger, and/or desolventizer-toaster. In any case, the solvent separated from the solvent-wet extracted solids stream via desolventizer 28 can be recycled back to extractor 12 for reuse (optionally with further processing, such as to decrease the water content in the solvent stream, before being returned to the extractor).

Independent of whether extractor system 10 includes desolventizer 28, extractor 12 in the extractor system can produce miscella 116 that discharges through solvent outlet 26. Because the miscella contains solvent intermixed with extracted oil, the miscella stream may be further processed separate the solvent from the oil. The miscella 116 can be further processed to help separate the oil faction of the miscella stream from the solvent fraction, thereby producing an extracted oil and recovered second solvent.

In the example of FIG. 1, system 10 includes a cooling unit 30 that is configured to receive miscella stream 116 and cool the stream to promote liquid-liquid phase separation between the aqueous alcohol-based second solvent component of the miscella and the extracted oil component of the miscella. Cooling unit 30 may be implemented using one or more heat exchangers or other thermal transfer devices that reduce a temperature of the miscella stream to a temperature effective to cause phase separation. In some examples, cooling unit 30 cools miscella 116 to a temperature less than 40 degrees Celsius, such as less than 30 degrees Celsius, or less than 25 degrees Celsius (e.g., a temperature ranging from 15 degrees Celsius to 25 degrees Celsius, such as approximately 20 degrees Celsius).

Cooling the miscella stream can produce a first solvent-rich phase and a first oil-rich layer. A compositional gradient may exist between the solvent-rich phase and the oil-rich phase formed by cooling the miscella stream. In either case, in the example of FIG. 1, extraction system 10 includes a separator 32 to separate the first solvent-rich phase from the first oil-rich phase. Separator 32 may be implemented using a decanter (e.g., gravity decanter) and/or other liquid separation device, such as a centrifuge and/or cyclone. Separator 32 can separate the solvent-rich layer from the oil-rich layer to produce a separated first oil-rich phase/stream 120 and a separated first solvent-rich phase/stream 122. The two separate streams may be recycled and/or further processed.

For example, the separated first solvent-rich stream 122 may be further processed with a secondary separator 34 to help remove residual oil from the stream. A secondary separation can be performed on the first separated solvent-rich stream to form a separated solvent stream and a second separated oil-rich stream. Secondary separator 34 may be, or include, one or more separation devices configured to further separate residual oil from the solvent in the separated first solvent-rich stream 122. In some implementations, secondary separator 34 includes a mechanical separation device, such as a centrifuge and/or a cyclone. Additionally or alternatively, secondary separator 34 may be configured to promote flocculation of the oil and/or solvent factions in separated first solvent-rich stream 122 to promote further separation of the two fractions.

For example, extraction system 10 may be configured so an amount of water is added to the separated first solvent-rich stream 122 to promote further phase separation between the oil component of the stream and the solvent component in the stream. The amount of water added to the first separated solvent-rich stream 122 may be comparatively small, such as an amount of water that is less than 10 weight % of a weight of the separated first separated solvent-rich stream 122, such as less than 5 weight %, less than 3 weight %, less than about 1 weight %, less than about 0.5 weight %, less than about 0.2 weight %, or less than about 0.1 weight %. In some examples, mixing equipment such as a static mixer, dynamic mixer, and/or homogenizer may be used to facilitate mass transfer between the phases and promote further phase separation.

Adding an amount of water to the separated first separated solvent-rich stream 122 can cause further liquid-liquid phase separation between the oil component in the stream and the solvent component (e.g., alcohol) in the stream. This can form a second solvent-rich layer phase separated from a second oil-rich phase. A compositional gradient may exist between the solvent-rich phase and the oil-rich phase formed by adding water to the first separated oil-rich stream.

In addition to or in lieu of adding water to promote further separation of the first separated solvent-rich stream 122, the secondary separator may further cool the first separated solvent-rich stream. For example, secondary separator 34 may cool the first separated solvent-rich stream 122 to a temperature less than a temperature to which the miscella by cooling unit 30. In these implementations, secondary separator 34 may include one or more heat exchangers or other thermal transfer devices that reduce a temperature of the first separated solvent-rich stream 122. In some examples, secondary separator 34 reduces the temperature of the first separated solvent-rich stream 122 to a temperature at least 5 degrees Celsius less than a temperature to which the miscella stream was cooled by cooling unit 30, such as a temperature at least 10 degrees Celsius less, at least 15 degrees Celsius less, at least 20 degrees Celsius less, or at least 25 degrees Celsius less. The cooling may promote phase separation between the aqueous solvent and the oil fractions.

In either case, secondary separator 34 may generate a second oil-rich phase 124 and a second solvent-rich phase 126. The separator (e.g., secondary separator 34) may be implemented using a decanter (e.g., gravity decanter) and/or other liquid separation device, such as a centrifuge and/or cyclone.

First solvent-rich phase 122 generated by separator 32 and/or second solvent-rich phase 126 generated by secondary separator 34 (which used) may be further processed and/or recycled. In some examples, first solvent-rich phase 122 generated by separator 32 and/or second solvent-rich phase 126 generated by secondary separator 34 are processed by water removal unit 18 (or another water removal unit configured as described above with respect to water removal unit 18) to remove water from the solvent-rich stream prior to further reusing the recovered solvent. For example, first solvent-rich phase 122 generated by separator 32 and/or second solvent-rich phase 126 generated by secondary separator 34 may be processed by water removal unit 18 to remove water as discussed above, thereby generating a recovered second solvent (e.g., having the same composition as second solvent 114).

Extractor 12 can be implemented using any suitable type of extractor configuration. For example, extractor 12 may be an immersion extractor, a percolation extractor, or yet other type of extractor design. In one example, extractor 12 is a shallow bed continuous loop extractor.

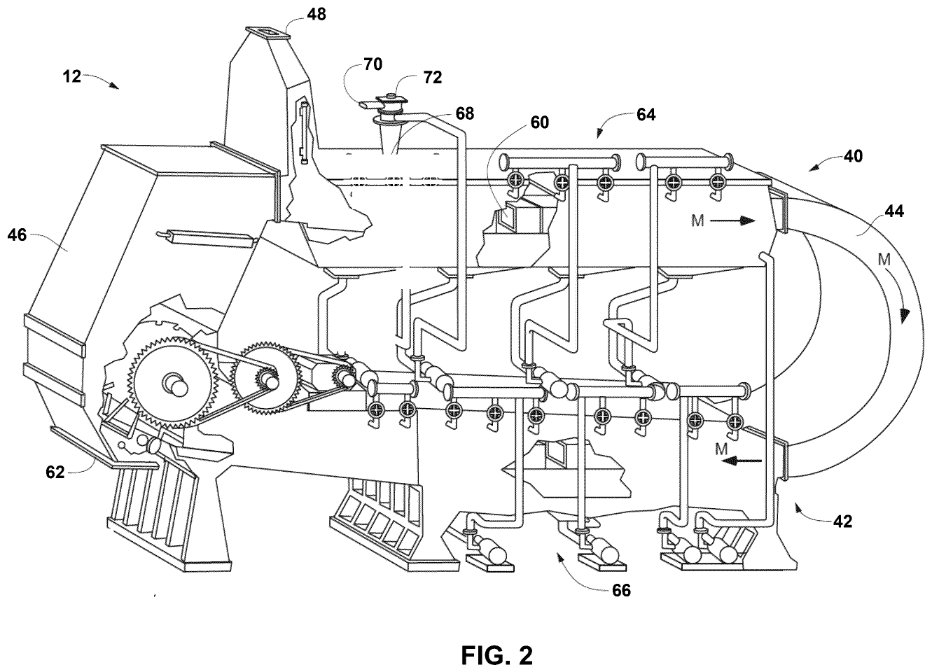

FIG. 2 is an illustration of an example extractor configuration that can be used for extractor 12. In the example shown, extractor 12 includes a housing defining a passageway in the form of a loop disposed in a vertical plane. The extractor can include upper and lower extraction sections 40, 42 each with a series of extraction chambers, a generally arcuate hollow transfer section 44 having its opposite upper and lower ends connected to first ends of the upper and lower extraction sections respectively, and a hollow, generally vertical return section 46 connected at its upper and lower ends respectively to the other ends of the upper and lower extraction sections. The upper extraction section can include an inlet portion 48 for delivery of solid material to the interior thereof in closely spaced relation to the upper end of the return section, and the lower end of the return section can define an opening 62 for discharge of the material after the product-of-interest has been extracted therefrom. The number of extraction chambers, or stages, provided by the extractor can vary depending on the desired sized of the extractor. The extractor includes at least one extraction chamber, or stage, and typically includes multiple stages (e.g., 6 stages, 8 stages, or more). A Model III extractor commercially available from Crown Iron Works Company of Minneapolis, MN, is a specific example of an extractor of this type.

In such an extractor, a conveyor system 60 can extend longitudinally through the looped passageway and be driven in a material flow direction “M” to move the material as a bed from the inlet portion 48 through the upper extraction section 40 toward and downwardly through the transfer section 44, and through the lower extraction section 42 toward the lower end of the return section and the discharge opening 62. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 64 can be disposed above the solid materials and configured to apply a fluid to the solid materials in each extraction chamber, and a fluid removal system 66 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 2, fluid having passed through the solid material is collected by the fluid removal system 66 and delivered to a separation device 68, which in the illustrated example is shown as a cyclone-type separator to separate any solid fines from the fluid before fluid discharge. An outlet conduit 70 of separation device 68 can deliver the fluid, generally a mixture of extraction fluid and soluble components extracted from the solid material into the extraction fluid (e.g., oil when processing oil seed) (commonly known as “miscella”), to other equipment, not shown, for separating the extraction fluid from the material extracted from the solid material being processed. A separate outlet 72 of separation device 68 can deliver a stream containing particulate matter separated from the miscella for further processing, as described herein.

As material is conveyed through extractor 12, spray headers from the fluid supply system 64 spray recycled extraction fluid on the top of the material. The material percolates through the material and through the screen, where it is collected in the network of drain pipes and delivered back to the network of spray headers where it is reapplied to the solid material in a different extraction chamber. In some embodiments, fresh secondary solvent is applied to the material in the last extraction chamber before the solid material discharge 62. For example, fresh secondary solvent may be applied to the material in the last extraction chamber before discharge 62 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 62 and an enriched extraction fluid outlet adjacent inlet 48, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 48 to a comparatively low concentration at the outlet 62.

An alcohol-based solvent extraction process according to the present disclosure may provide various advantages over an extraction process that does not use an alcohol-based solvent. For example, an alcohol-based solvent may provide better compatibility with food supply chains. Ethanol is GRAS (Generally Recognized As Safe), can be produced organically from renewable feedstocks, and is already consumed directly as a component of alcoholic beverages. As another example, an alcohol-based solvent may improve the processed product attributes of some feedstocks. When applied to soybean flakes, for instance, an alcohol-based solvent may produce a meal with less “beany” flavor and less color. When applied to either soybean flakes or cottonseed meats, an alcohol-based solvent may alter protein solubility and lower antinutritional factor content. The alcohol-based solvent may produce an oil with lower wax and phosphatide content.

Various examples have been described. These and other examples are within the scope of the following claims.

1. A method comprising:
removing water from an oil-containing material to be processed by contacting the oil-containing material with a first solvent comprising ethanol at a temperature below that at which oil substantially extracts from the oil-containing material into the first solvent, thereby producing a dehydrated oil-containing material and a residual solvent comprising the first solvent and water removed from the oil-containing material;
separating the residual solvent from the dehydrated oil-containing material and removing water from the residual solvent to recover the first solvent;
contacting the dehydrated oil-containing material with a second solvent comprising ethanol in an extractor at a temperature above that at which oil substantially extracts from the dehydrated oil-containing material into the second solvent, thereby producing an extracted material and a miscella; and
separating the second solvent from the miscella, thereby forming an extracted oil.

2. The method of claim 1, wherein removing water from the oil-containing material to be processed by contacting the oil-containing material with the first solvent at the temperature below that at which oil substantially extracts from the oil-containing material into the first solvent comprises contacting the oil-containing material with the first solvent at a temperature from 0 degrees Celsius to 30 degrees Celsius.

3. The method of claim 1, wherein contacting the dehydrated oil-containing material with the second solvent in the extractor at the temperature above that at which oil substantially extracts from the oil-containing material into the second solvent comprises contacting the dehydrated oil-containing material with the second solvent in the extractor at a temperature greater than 50 degrees Celsius.

4. The method of claim 1, wherein the first solvent is a same composition solvent as the second solvent.

5. The method of claim 1, wherein the first solvent is segregated from the second solvent.

6. The method of claim 1, wherein the first solvent and the second solvent each comprise greater than 90 weight percent ethanol and less than 10 weight percent water.

7. The method of claim 1, wherein separating the residual solvent from the dehydrated oil-containing material comprises at least one of gravity draining and pressing.

8. The method of claim 1, wherein removing water from the residual solvent to recover the first solvent comprises processing the residual solvent in a molecular sieve and/or a pervaporation system.

9. The method of claim 8, further comprising removing oil from the residual solvent prior to processing the residual solvent in the molecular sieve and/or the pervaporation system.

10. The method of claim 8, further comprising one or more of filtering, centrifuging, and decanting the residual solvent prior to processing the residual solvent in the molecular sieve and/or the pervaporation system.

11. The method of claim 1, further comprising recycling the first solvent recovered from the residual solvent back to contact an additional portion of the oil-containing material.

12. The method of claim 1, wherein removing water from the oil-containing material to be processed thereby producing the dehydrated oil-containing material comprises reducing a water content of the dehydrated oil-containing material to 3 weight percent.

13. The method of claim 1, wherein:
removing water from the oil-containing material at the temperature below that at which oil substantially extracts from the oil-containing material comprises removing less than 10 wt % of an oil in the oil-containing material with the first solvent; and
contacting the dehydrated oil-containing material with the second solvent at the temperature above that at which oil substantially extracts from the dehydrated oil-containing material into the second solvent comprises removing greater than 80 wt % of the oil in the dehydrated oil-containing material with the second solvent.

14. The method of claim 1, wherein the oil-containing material to be processed exhibits a water content greater than 8 weight percent prior to contacting the oil-containing material with the first solvent.

15. The method of claim 1, wherein removing water from the oil-containing material to be processed by contacting the oil-containing material with the first solvent comprises soaking the oil-containing material in the first solvent for a period of time of at least 10 minutes.

16. The method of claim 1, wherein separating the second solvent from the miscella, thereby forming the extracted oil, comprises:
cooling the miscella to form a solvent-rich phase and an oil-rich phase; and
separating the solvent-rich phase from the oil-rich phase.

17. The method of claim 16, wherein separating the solvent-rich phase from the oil-rich phase comprises decanting the solvent-rich phase from the oil-rich phase.

18. The method of claim 17, further comprising removing water from the solvent-rich phase to recover the second solvent, and recycling the second solvent recovered from the solvent-rich phase back to the extractor.

19. The method of claim 18, wherein removing water from the solvent-rich phase to recover the second solvent comprises processing the residual solvent rich phase in a molecular sieve and/or a pervaporation system.

20. The method of claim 1, wherein the oil-containing material to be processed is a soy material, and further comprising desolventizing the extracted material, thereby forming a dried extracted material.
